(19) United States
(12) Patent Application Publication
(10) Pub. No.: US 2004/0243598 A1
(43) Pub. Date: Dec. 2, 2004

(54) Method and system for managing database SQL statements in web based and client/server applications

(76) Inventors: Dean A. Sleeper, Seattle, WA (US); Mallikarjuna Gumma, Bellevue, WA (US); Jonathon Moulton, Seattle, WA (US); William Bamum, Anacortes, WA (US); Thomas Peashka, Spokane, WA (US)

Correspondence Address: OLYMPIC PATENT WORKS PLLC, P.O. BOX 4277, SEATTLE, WA, 98104, US

(21) Appl. No.: 10/796,581

(22) Filed: Mar. 8, 2004

Related U.S. Application Data
(60) Provisional application No. 60/452,643, filed on Mar. 6, 2003.

(51) Int. Cl. G06F 7/00

(52) U.S. Cl. 707/100

(57) ABSTRACT

One embodiment of the present invention is a tokenized SQL architecture that provides a process for enabling application designers and developers to construct and manage database independent SQL statements and use them in Web based or client/server applications. The tokenized SQL architecture (“TSA”) uses a proprietary file format, plus a variety of components and utilities, to allow for both maximum design-time flexibility and maximum run-time performance on the target database. For example, the TSA allows application developers working with the latest data-driven web or C/S technology to create, modify and test SQL statements in a an easy to use folder and file based form. Once the SQL is tested and debugged, a utility is used to take all the SQL statements used in an application and generate each statement as a Database Stored Procedure (“DSP”). Then the developer flips an application variable and the entire application will switch over to using stored procedures maximum speed, scalability and efficiency. Additionally UI and output template authors and designers can use the original SQL files directly without having to have the variable substitution support provided by the application run-time environment.

### CROSS-REFERENCE TO RELATED APPLICATION

This application claims the benefit of Provisional Patent Application No. 60/452,643, filed Mar. 6, 2003.

### TECHNICAL FIELD

The present invention is related to application development and embedded relational database calls within application programs, and, in particular, to a method and system for providing database-independent and embedded-SQL/stored-procedure-independent calls for application development that can be easily toggled to function as interfaces to various different DBMSs and to function either as embedded database calls or as stored procedure calls.

### BACKGROUND OF THE INVENTION

Typical problems associated with developing applications that interface to relational DBMSs include: the disconnect between a fluid design-time application environment vs. the “locked-down” run-time application environment; applications that break when database or systems architecture's change; and non-modular content and form components that have intertwined SQL statements and application code.

All of these problems are exacerbated by the increased use of SQL as a point for integration between applications, and as a source of business object rules. Applications continue to migrate towards database centric solutions, where more logic is stored with the database content rather than within the application code. Unfortunately, many developers embed much of the SQL used to access these business data and rules into the application code itself, negating some of the benefits.

One approach is to make a DBMS Stored Procedure call from the application code rather than building an SQL statement in the application code then calling the DBMS engine. But working with Stored Procedures is more cumbersome than file based SQL especially with other third party tools like source control, report writers, template design tools and merge utilities. Even SQL Query development tools delivered with the DBMS software or provided by third parties work more simply with file based SQL statements rather than stored procedures. Ultimately however, SQL wants to run as a stored procedure within the database for maximum speed and efficiency. This is the “disconnect” between design-time and run-time SQL development. Development tools are geared around building SQL statements in a file based architecture, and production databases are built around SQL statements coded within the database server.

In some cases application code is modified, typically at the last minute, to change from embedded SQL to embedded SP calls. But this means changing the code back to embedded SQL in order to easily add major features or it means modifying the stored procedure directly to correct SQL mistakes. When SQL code is done in stored procedure it becomes much more difficult to port to other database platforms as SP syntax and “language” definitions vary more greatly between DBMS then does the SQL syntax, normally written in the SQL-92 standard. Even many SQL statement syntaxes are DBMS particular and if these become embedded in the application code then the code is not portable between DBMS. One advantage to moving to stored procedures though is that applications have better separation between form or UI and application content making any application changes simpler. Either way there is no simple way to use the third party dev tools to test, debug and correct the SQL statements.

So if you keep the code as embedded SQL you have better DBMS platform portability but more difficulty making code changes, especially since many changes involve just the content logic. Every time you change application code you typically need to recompile, link and redistribute the code as well as thoroughly test the application. Additionally, when SQL statements are coded directly in code or as stored procedures the syntax used for parameters or variables typically need to express the data types or those parameters. So even if the SQL itself doesn't change the code may have to if the data types for variables used in the code are changed. This indicates a need for a product that supports multiple SQL coding techniques and has runtime substitution of tokens including determining their data types but also allows flexible design of SQL that can be easily put into stored procedures for performance reasons.

### SUMMARY OF THE INVENTION

One embodiment of the present invention is the Tokenized SQL Architecure (“TSA”), composed of three important technologies: the tokenized SQL file or .SQT file, the ExpandTokenizedSQL function and the CSP utility. Enhancing the development advantages of TSA is any template based rendering engine and authoring environment.

The tokenized SQL file or .SQT file is a file format that contains a single SQL statement plus parameter and data type information (or tokens). This is a simple ASCII file using section and entry conventions similarl to a MS Windows based .INI file. The SQT file may include an [SQL] section and a [TOKENS] section. In TSA terms the variables or parameters used in any SQL are Tokens since they represent both a parameter, it's run-time or design-time value as well as data type information about the parameter. The embedded token syntax includes an @ symbol directly in front of the variable that you want expanded. This method was selected since it is identical to a stored procedure “named parameters” type syntax. Normally, the SQL is ready to run inside the target DBMS stored procedure environment as well as ready to run as dynamic SQL with the exception of specifying the parameter values.

The SQL statement can easily be cut and paste into query editors or other development tools with valid values to supply to the parameters included in the file. No application code programming syntax such as concatenation operators or quotes need to be modified in order to run the statement. If used with the AccessVia template authoring tool, no cut and paste operation is required. Important to making SQL easy to develop with is this tokenized SQL file or .SQT file.

The ExpandTokenizedSQL function can take a variety of SQL statement input sources, with the input type being declared by the source type parameter. Normally, in a development or design mode during the application development process, an SQT file name is provided with token names and values and the “File” source type. During production mode, this SQT file name will represent a stored procedure name and the appropriate parameter values specified along with the “Stored Procedure” source type. Other source types are also supported. See the function prototype in section 4.2 below.

The TSA includes an SQT2SP utility. This utility executable takes a folder of SQT files and generates all of the necessary stored procedure code for the database. This has been customized to use XML with DBMS specific XSL to easily support any new or existing DBMS. This utility reads an INI file that stores folder locations, a database connection string, and XSLT stylesheets to plug in at run time for the various database vendors. It will read in all of the SQT files in the source directory and process them. Optionally, it will read generate a new set of correct default values for entries in the [TOKENS] section. This insures that the default values stay in sync and up to date in the SQT file so that when a template author links to that SQT file it will run with current default values.

The TSA allows the code to be data type independent by pushing the SQL and data type specifications into the SQT file, without requiring difficult SQL parsing. The TSA specifies a matching table and column name reference for each parameter so that it's type can be easily tested. These entries are included in the [TOKENS] section. However, not all stored procedure parameters map directly to a table and column name so it is also an option to specify the specific data type. The table is opened to get the column info, which creates a performance hit, but in design mode this is fine, in production mode this will not be necessary as all of the data type information will have already been correctly generated for the stored procedure. The two purposes of these entries are to determine if quote characters need to be placed around the values for the appropriate parameter types and to generate the specific data types necessary to generate the stored procedure call. Additionally, the [TOKENS] section entries can supply an actual or default value to be used with development tools like query editors.

The TSA supports more than one method of parameter calling to allow flexibility with an order or precedence. The ExpandTokenizedSQL function scans the SQL parameters and changes any quote provided to the correct quote required by the connected DBMS. For example, if the DBMS requires double quotes around string values and the user supplied single quotes then the single quotes are changed to double quotes. This makes the supplied SQL statement more portable though some parameters for SQL server that identify tables, columns or keywords will want to stay in double quotes. Quotes embedded in a value that are the same as the DBMS delimiting quote will now be escaped by doubling the value. If table and column names are provided in the [TOKENS] section then use them as described If no tokens or quotes are provided then pass the parameter as is.

### BRIEF DESCRIPTION OF THE DRAWINGS

FIG. 1 illustrates a development process diagram.

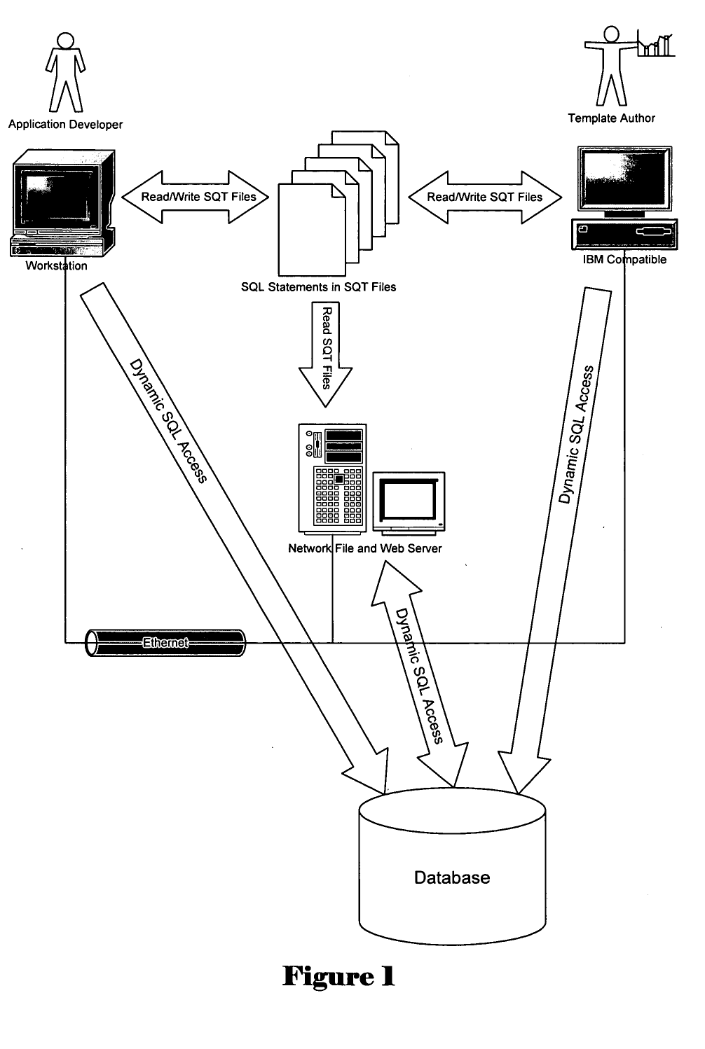

FIG. 2 illustrates moving a tokenzed SQL to production mode.

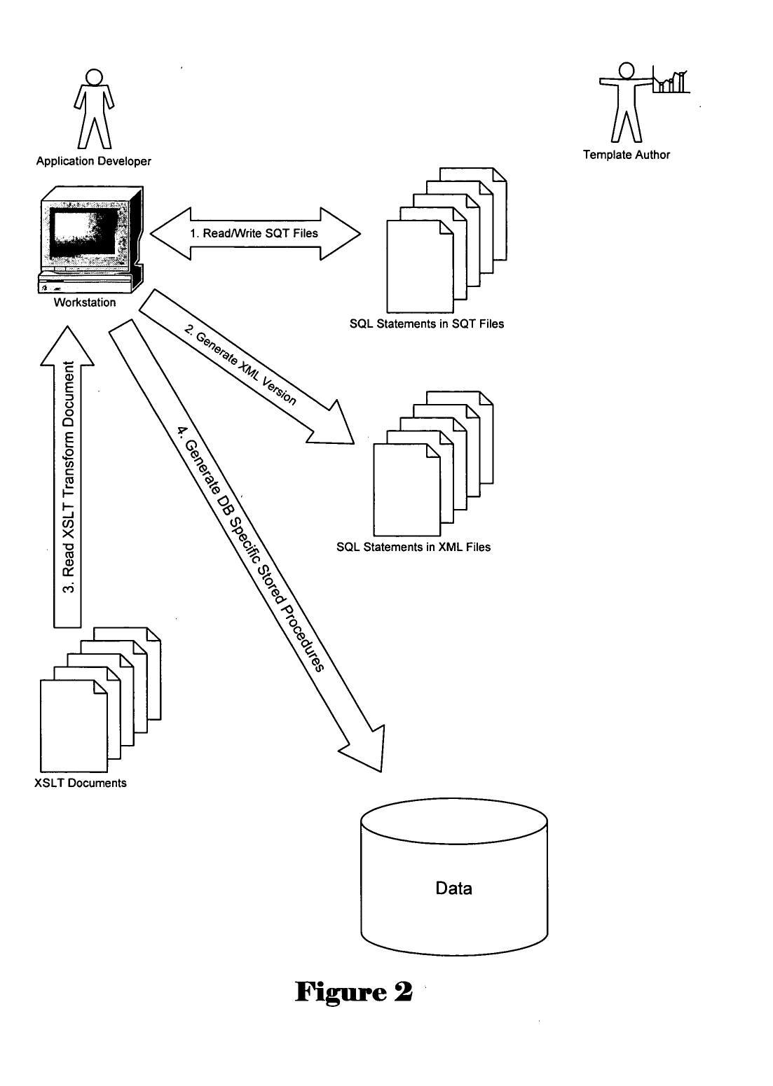

FIG. 3 illustrates tokenized SQL production deployment.

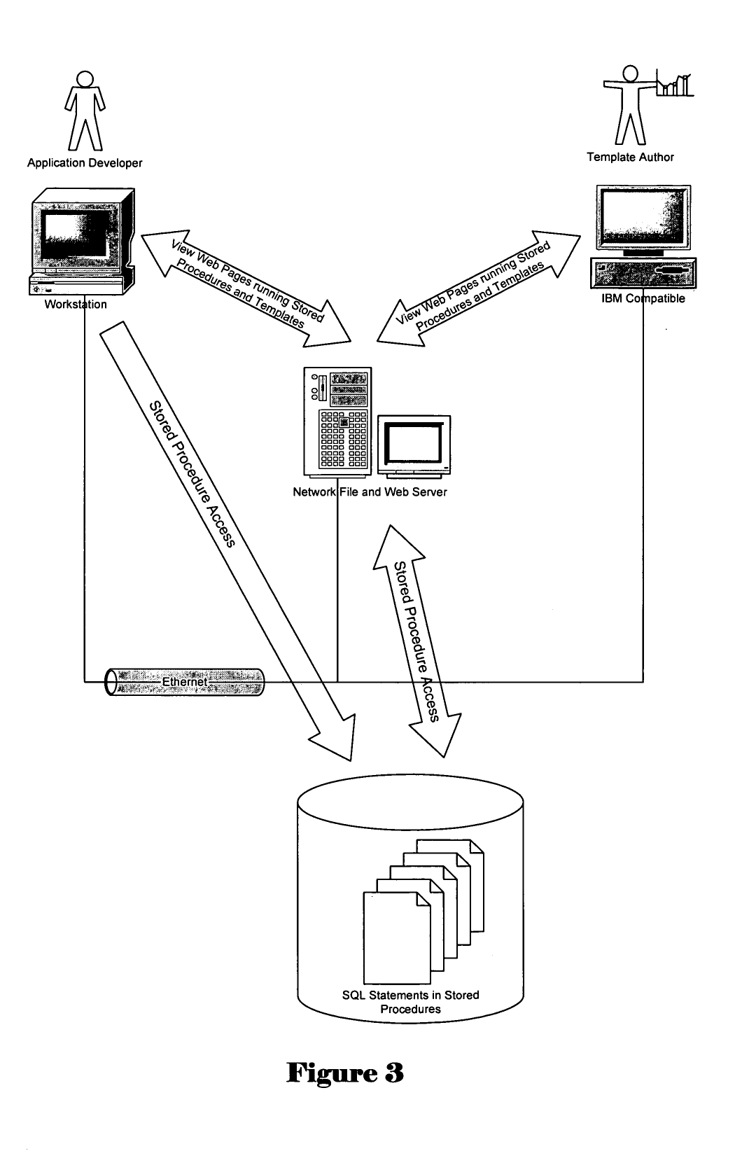

### DETAILED DESCRIPTION OF THE INVENTION

1.1 SQT2SP Utility Usage

To convert SQT files to Stored Procedures run the SQT2SP utility by directing it to a folder of SQT files and a DSN. It will generate an output file that is ready to load all the appropriate stored procedures in the database server DSN specified. The developer then changes the global eSource variable in the appliction from the rddFile to the rddStoredProc value and the application will now run against the stored procedures. To support stored procedures, the SQT files need to have correctly specified entries. The [TOKENS] section should have all token names (without the leading @ sign) with each followed by an equal sign (=) and then a actual or sample value that is formatted for the correct data type (′ or ″ for strings, nothing for numbers). The token entry will be preceded by a table.columname value that matches the token names correct data types, if no table.columname combination is available for the variable then the DBMS specific data type is declared (like VarChar(20) or int). If the CreateSP.exe has trouble converting certain SQT files it is because they do not meet the [TOKENS] section entry requirements.

For each file, it will first convert the SQT file to an XML doc that is a “flat” XML document, meaning it has sections and rows elements only, no real structured content. This file is then converted to a “SQTDef” XML doc in memory using an xslt style sheet ‘SQTFile2SQTDef.xslt’. This work is done in 2 parts: phase 1 does everything but the database lookup to get data types for the parameters. Phase 2 hits the database for the data types and converts from vendor-specific DBMS data types to OLEDB data types. This is a more robust XML schema. This will then be validated with another xslt style sheet, valSQTDef.xslt. It's a touch harder to validate with xslt than with code (xslt doesn't do substrings very well), it's also more maintainable without recompiling. The “transformed” SQTDef xml doc is a plain text memory stream that is then written out to a log file if there are errors. This uses xslt extension objects that call back from xslt to C#. If the SQTDef is valid, there is a final conversion to a stored procedure with a vendor-specific xslt style sheet, of which there is an SQL Server example provided. A different XSLT style sheet is for each different database vendor. All stored procedures can get written to a single file or optionally written to one stored procedure file per SQT file. These outputted stored procedures file can the loaded into a query editor or command environment for the database and executed, generating all of the stored procedures required for that application.

1.2 Expand Tokenized SQL prototype

Thomas Update Here:

| | | |
|---|---|---|
| RDDAPI(RC) | | ExpandTokenizedSQL( |
| IN | DBC* | pDBC, |
| IN | long | fSource, |
| IN | pszSourceSQL, | |
| OUT | char * | pszExpandedSQL, |
| OUT | long * | pcbExpandedSQL, |
| IN | char * | pszTokenValues |
| ); | | |

| pDBC | Pointer to a DBC. | |
|---|---|---|
| | This may be NULL for FILE and PARM sources. | |
| fSource | Defines the source of the SQL statement. May | |
| be: | | |
| | SQL_SOURCE_FILE | Get the SQL from a |
| | | file |
| | SQL_SOURCE_TABLE | Get the SQL from a |
| | | table |
| | SQL_SOURCE_PARM | The SQL is |
| | | passed in |
| pszSQLSource | | |
| | SQL_SOURCE_PROC | The SQL is a stored |
| procedure. | | |

| | |
|---|---|
| pszSourceSQL | String containing filename, record key or |
| SQL | |
| pszExpandedSQL | Pointer to a buffer for expanded SQL |
| statement. | |
| | This buffer is allocated by the caller. You |
| may | |
| | call the function with this parameter set to |
| NULL and | |
| | the required buffer length will be returned |
| in | |
| pcbExpandedSQL. | |
| pcbExpandedSQL | Length of the expanded SQL statement buffer. |
| pszTokenValues | Pointer to Key=value; pairs for tokens. |
| | Each key=value pair needs to be terminated |
| by a semi-colon. | |

Expand Tokenized SQL Function Usage

ExpandTokenizedSQL function calls returns an executable SQL statement string with any string tokens replaced by values specified in Token Values parameter. Or it the stored procedure name then parameter list and this stored procedure parameter list will include the ‘single quote’ for the string parameter, date parameter etc since the stored procedures expects single quote with strings and date type input parameter list. For eSource=rddTable, the ActiveConnection property needs to be set with an active connection object. For eSource=rddFile, the SourceSQL can either be a fully qualified file name or file name with no path information. For a file name with no path information, the object assumes the file is located in the current vDir.

```
rc = rddExpandTokenizedSQL(pDBC,
  SQL_SOURCE_FILE | SQL_SOURCE_PROC,
  “\\ADirectory\AFile.sqt”,
  &pszSQLBuffer,
  &cbSQLBuffer,
  “strOrgName=SIGN & strSignType=TYPE”
  );
```

Token Values parameter specifies the list of token/value pairs to replace tokenized parameters in the SourceSQL. This parameter string needs to be in the format:

| | |
|---|---|
| token=value | for a single token/value pair |
| or | |
| token(1)=value(1)&token(2)=value(2) | for n token value pairs |
| &...&token(n) =value(n) | |

The eSource parameter is an enumerated value which specifies the SQLSource type. This value is defaulted to rddString and is not required. Get the SQL source from the passed in parameter, a file, SGSQL table record for just build the stored procedure call. Possible eSource values are:

| | |
|---|---|
| rddFile | the SQLSource is the name of a file or a fully qualified |
| | file name. |
| rddStoredProc | the SQLSource is the name of a stored procedure |
| rddString | the SQLSource is a SQL statement string |
| rddTable | the SQLSource is the name of a primary key value in |
| SGSQL | |

Null string values are accepted by rddExpandTokenized SQL. When passing in the substitution values in the pszTokenValues parameter DO NOT pass in token value pairs that have no value and allow the default token to assign the value. Then when rddExpandTokenizedSQL is called pass in the tokens that have actual values, the others will be set to NULL by default if the NULL is specified in the [TOKENS] section for the token entry. This way SQL UPDATE or INSERT statements with tokens that may or may not have values can be used. Putting in two double quotes and double quotes around a space is difficult to read and may lose that token and all subsequent tokens. This way the ExpandTokenizedSQL function will provide the necessary values and something in the statement to indicate “this field empty” to the DB.

For example:

[TOKENS]

BUS_SCHEDULE.BUS_ROUTE BusRoute=NULL

Function Internals:

1. Check all parameters for valid values.

2. Read the tokenized SQL source from a file, table, or string buffer

3. If the source is in a file or table the [TOKENS] entry may be included in the source If they are present then read and concatenate with pszTokenValues.

4. Expanded the tokenized SQL, substituting token values where supplied

1.3 Sample database table named BUS_SCHEDULE

| BUS_{—} | ROUTE_{—} | BUS_{—} | ARRIVAL_{—} |
|---|---|---|---|
| ROUTE | DIRECTION | STOP | TIME |
| NUMERIC(4) | VARCHAR(20) | VARCHAR(40) | DATETIME |
| 8 | Southbound | 15^{th} Ave and 80 St | 8:07 AM |
| 8 | Southbound | 15^{th} Ave and 65 St | 8:10 AM |
| 8 | Southbound | 15^{th} Ave and 45 St | 8:13 AM |
| 8 | Southbound | 15^{th} Ave and Main St | 8:20 AM |

1.4 Example SQL Program without TSA

‘Initialize the MS ADO connection object and open a new connection

Dim oConn as New ADODB.Connection

oConn.Open “driver={SQL Server};server=DB_SERVER;user id=sa;password=;database=BUS_SCHEDULE;”

‘Initialize the recordset object and open a new recordset using the connection and SQL statement

Dim rsBus as New ADODB.RecordSet

‘Build the SQL Statement using variables for the bus route

‘normally these variables are determined by some user interface calls

Dim numBusRoute=8

Dim strRouteDirection=“Southbound”

‘note the included quotes around the RoutDirection variable

Dim strSQLstatement=“SELECT*FROM BUS_SCHEDULE WHERE BUS_ROUTE=“ & numBusRoute & “ROUTE_DIRECTION=‘“ & strRouteDirection & ”’”

Set rsBus=oConn.Execute(strSQLstatement)

‘THE REST IS THE SAME FOR ALL EXAMPLES

‘walk the recordset, printing the route, stop and arrival time

While Not rsBus.EOF

Debug.Print “Route: #” & rsBus(“BUS_ROUTE”) & “ “& rsBus(“ROUTE_DIRECTION”) & “Stop: “& rsBus(“BUS_STOP”) & “Time: “& rsBus(“ARRIVAL_TIME”)

rsBus.MoveNext

Wend

rsBus.Close

oConn.Close

1.5 Sample Tokenized SQL (SQT) File used with Example

BUS_ROUTE.SQT

[SQL]

SELECT*FROM BUS_SCHEDULE

WHERE BUS_ROUTE=@BusRoute AND ROUTE_DIRECTION=@RouteDirection

[TOKENS]

BUS_SCHEDULE.BUS_ROUTE BusRoute=0

BUS_SCHEDULE.ROUTE_DIRECTION RouteDirection=‘Northbound’

[COMMENTS]

select statement for use with printing a bus schedule

1.6 Example SQL Program with SQT File

‘Initialize the AccessVia database connection object and open a new connection

Dim oConn as New RDD.Connection

oConn.Open “driver={SQL Server};server=DB_SERVER;user id=sa;password=;database=BUS_SCHEDULE;”

‘Initialize the command object to parse the SQT file and open a new recordset using the connection and SQL statement

Dim oCommand as New RDD.Command

‘Build the SQL Statement from the SQT file using variables for the bus route

‘normally these variables are determined by some user interface calls

Dim numBusRoute=8

Dim strRouteDirection=“Southbound”

‘normally this eSource variable is defined globally from a configuration table or file

Dim eSource=rddFile ‘source for SQT statement is from file, not string or stored procedure

‘note that no quotes are required around the route direction value

Dim vTokens=“BusRoute=” & numBusRoute & “&RouteDirecton=” & strRouteDirection

Dim strSQLstatement=oCommand.ExpandTokenizedSQL(“BUS_ROUTE.SQT”,vTokens,eSource)

oCommand.Close

‘Initialize the recordset object and open a new recordset using the connection and SQL statement

Dim rsBus as New RDD.RecordSet

Set rsBus=oConn.Execute(strSQLstatement)

‘THE REST IS THE SAME AS EXAMPLE 5.5

‘walk the recordset, printing the route, stop and arrival time

While Not rsBus.EOF

Debug.Print “Route: #” & rsBus(“BUS_ROUTE”) & “ “& rsBus(“ROUTE_DIRECTION”) & “Stop: “& rsBus(“BUS_STOP”) & “Time: “& rsBus(“ARRIVAL_TIME”)

rsBus.MoveNext

Wend

rsBus.Close

oConn.Close

1.7 Example Stored Procedure Program without TSA

‘Initialize the MS ADO connection object and open a new connection

Dim oConn as New ADODB.Connection

oConn.Open “driver={SQL Server};server=DB_SERVER;user id=sa;password=;database=BUS_SCHEDULE;”

‘Open a command object for a stored procedure with two parameters, note this code is unique

Dim cmdBus as New ADODB.Command

Set cmdBus.ActiveConnection=oConn

cmdBus.CommandText=“BUS_ROUTE”

cmdBus.CommandType=adCmdStoredProc

cmdBus.Parameters.Refresh

‘Get parameter value, execute the command and store the results in a recordset

‘normally these variables are determined by some user interface calls

cmdBus.Parameters(1)=8

cmdBus.Parameters(2)=“Southbound”

‘Initialize the recordset object and open a new recordset using the command object Set rsBus=cmdBus.Execute( )

‘THE REST IS THE SAME AS EXAMPLE 5.5

‘walk the recordset, printing the route, stop and arrival time

While Not rsBus.EOF

Debug.Print “Route: #“& rsBus(“BUS_ROUTE”) & “ “& rsBus(“ROUTE_DIRECTION”) & “Stop: “& rsBus(“BUS_STOP”) & “Time: “& rsBus(“ARRIVAL_TIME”)

rsBus.MoveNext

Wend

rsBus.Close

oConn.Close

1.8 Sample Stored Procedure used with Example

CREATE PROCEDURE BUS_ROUTE (@BusRoute as Numeric(2), @RouteDirection as VarChar(20))

AS

BEGIN

SELECT*FROM BUS_SCHEDULE

WHERE BUS_ROUTE=@BusRoute AND ROUTE_DIRECTION=@RouteDirection

END

GO

1.9 Example Stored Procedure Program with TSA

‘Initialize the AccessVia database connection object and open a new connection

Dim oConn as New RDD.Connection

oConn.Open “driver={SQL Server);server=DB_SERVER;user id=sa;password=;database=BUS_SCHEDULE;”

‘Initialize the command object to parse the SQT file and open a new recordset using the connection and SQL statement

Dim oCommand as New RDD.Command

‘Build the SQL Statement from the SQT file using variables for the bus route

‘normally these variables are determined by some user interface calls

Dim numBusRoute=8

Dim strRouteDirection=“Southbound”

‘normally this eSource variable is defined globally from a configuration table or file

Dim eSource=rddStoredProc 'source for SQT statement is from stored procedure

‘THE ABOVE LINE IS THE ONLY DIFFERENCE FROM EXAMPLE 5.7

Dim vTokens=“BusRoute=” & numBusRoute & “&RouteDirection=” & strRouteDirection

Dim strSQLstatement=oCommand.ExpandTokenizedSQL(“BUS_ROUTE.SQT”,vTokens,eSource)

oCommand.Close

‘Initialize the recordset object and open a new recordset using the connection and SQL statement

Dim oRS as New RDD.RecordSet

Set rsBus=oConn.Execute(strSQLstatement)

‘THE REST IS THE SAME AS EXAMPLE 5.5

‘walk the recordset, printing the route, stop and arrival time

While Not rsBus.EOF

Debug.Print “Route: #” & rsBus(“BUS-ROUTE”) & “ “& rsBus(“ROUTE_DIRECTION”) & “Stop: “& rsBus(“BUS_STOP”) &“Time: “& rsBus(”ARRIVAL_TIME”) not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for application development comprising:
expressing database calls within an application as tokenized SQL statements;
initially processing the tokenized SQL statements in a database independent manner as embedded SQL; and
moving to production mode by processing the tokenized SQL statements to create callable stored procedures that reside within a database management system.
